(19) United States
(12) Patent Application Publication
(10) Pub. No.: US 2026/0178050 A1
(43) Pub. Date: Jun. 25, 2026

(54) AUTOMATIC TRAVERSAL TIME ESTIMATOR FOR LEVEL FLIGHT IN CRUISE

(71) Applicant: Rockwell Collins, Inc., Cedar Rapids, IA (US)

(72) Inventors: Shih-Yih Young, Marion, IA (US); Sebin K Kottackal, Bangalore (IN); Mark W. Volner, Huxley, IA (US); Dinesh Kumar Kushwaha, Bangalore (IN)

(21) Appl. No.: 19/427,191

(22) Filed: Dec. 19, 2025

(30) Foreign Application Priority Data
Dec. 19, 2024 (IN) 202411100793

(51) Int. Cl. G05D 1/65; G05D 1/229

(52) U.S. Cl. CPC G05D 1/651; G05D 1/229

(57) ABSTRACT

A system and method for predicting estimated times of arrival are disclosed. The system may include a controller configured to: receive a flight plan for an aircraft, define a ground path for the aircraft based on the flight plan with respect to an ellipsoidal model of Earth, and integrate along the ground path for each flight leg using an energy-based method to generate aircraft states. The integration may involve calculating ground speed, traversal time, fuel consumed, and gross weight of the aircraft, aggregating the traversal time of each integration step to determine a total traversal time for each waypoint, determining an estimated time of arrival at each waypoint based on the total traversal time, and directing a transmission indicative of the estimated time of arrival at each waypoint.

### CROSS-REFERENCE TO RELATED APPLICATIONS

The present application claims the benefit of India Provisional Patent Application 202411100793, filed Dec. 19, 2024, titled AUTOMATIC TRAVERSAL TIME ESTIMATOR FOR LEVEL FLIGHT IN CRUISE, which is incorporated herein by reference in the entirety.

### TECHNICAL FIELD

The present disclosure relates generally to aircraft flight prediction, and, more particularly, to determining estimated time of arrivals at each waypoint of a flight plan.

### BACKGROUND

The Aeronautical Telecommunication Network-Baseline 2 (ATN-B2) standard defines the Extended Projected Profile (EPP) message protocol that may be sent via Automatic Dependent Surveillance-Contract (ADS-C) from an aircraft to an air traffic management facility on the ground. The EPP message may contain a representation of the reference trajectory calculated by the Flight Management System (FMS) onboard the aircraft. One of the parameters within this EPP message is the Estimated Times of Arrival (ETAs) at waypoints listed in the EPP message.

The accuracy of an ETA at a given waypoint listed in the EPP message is required to be higher than 99% (i.e., within 1% error or 10 seconds) relative to the Actual Time of Arrival (ATA) by the aircraft at the same waypoint, by assuming both temperature and wind profiles of the flight are given and known. Most of the reference trajectory in the EPP message is under this flight condition of level flight in cruise.

There may exist a desire for a system and method that can meet the accuracy requirements for EPP messages.

### SUMMARY

A system for predicting estimated times of arrival is disclosed in accordance with one or more illustrative embodiments of the present disclosure. In one illustrative embodiment, the system includes a controller with one or more processors configured to execute a set of program instructions stored in a memory. In another illustrative embodiment, the program instructions are configured to cause the processors to receive a flight plan for an aircraft. In another illustrative embodiment, the ground path for the aircraft is defined based on the flight plan, where the ground path is defined with respect to an ellipsoidal model of Earth and includes a plurality of flight legs. In another illustrative embodiment, the system integrates along the ground path for each of the flight legs using an energy-based method to generate aircraft states. In another illustrative embodiment, the integration involves calculating ground speed, traversal time, fuel consumed, and gross weight of the aircraft. In another illustrative embodiment, the system aggregates the traversal time of each integration step to determine a total traversal time for each waypoint. In another illustrative embodiment, the system determines an estimated time of arrival at each waypoint based on the total traversal time. In another illustrative embodiment, the system directs a transmission indicative of the estimated time of arrival at each waypoint.

In further aspects, the ground speed may be based on a set of nominal auto-throttle parameters specific to an aircraft type of the aircraft. In another aspect, the fuel consumed is calculated based on a fuel flow rate, which is calculated based on a required thrust, where the required thrust is based on the set of nominal auto-throttle parameters specific to the aircraft type of the aircraft. In another aspect, for an integration step configured for acceleration, the controller is configured to receive an acceleration value specific to an aircraft type of the aircraft, calculate a dependent thrust value required for the aircraft to maintain a constant airspeed, calculate an additional thrust value required to maintain the acceleration value based on the gross weight of the aircraft, determine a total required thrust by combining the dependent thrust value and the additional thrust value, and update the aircraft states based on the total required thrust. In another aspect, for an integration step configured for deceleration, the controller is configured to determine a deceleration value specific to an aircraft type of the aircraft, calculate a dependent thrust value required for the aircraft to maintain a constant airspeed, calculate a thrust reduction value required to achieve the deceleration value based on the gross weight of the aircraft, determine a total required thrust by subtracting the thrust reduction value from the dependent thrust value, and update the aircraft states based on the total required thrust. In another aspect, the integrating along the ground path is configured to be performed during level flight while in a cruise mode. In another aspect, the ground speed is based on a true airspeed and wind data. In another aspect, each integration step further includes calculating the gross weight of the aircraft based on the fuel consumed. In another aspect, the transmission includes an Extended Projected Profile (EPP) message. In another aspect, the ellipsoidal model of the Earth is a WGS-84 ellipsoidal Earth model. In another aspect, the ground path includes a fixed radius transition between consecutive track-to-fix (TF) legs. In another aspect, defining the ground path includes calculating a radius of turn for each fixed radius transition of the plurality of flight legs by determining a first ground speed at a start point of the fixed radius transition, determining a second ground speed at a midpoint of the fixed radius transition, determining a third ground speed at an end point of the fixed radius transition, selecting a maximum ground speed from a group comprising the first ground speed, the second ground speed, and the third ground speed, and determining the radius of turn based on the maximum ground speed and a predetermined bank angle. In another aspect, calculating the ground speed for each integration step includes receiving wind magnitude data and wind direction data, calculating an along-track wind component and a cross-track wind component based on the wind magnitude data, the wind direction data, and a current aircraft track angle, determining a true airspeed component adjusted for the cross-track wind component, and calculating the ground speed by combining the true airspeed component with the along-track wind component. In another aspect, the system includes a flight management system comprising the controller and wherein the controller is an aircraft controller, and the system further includes a sensor configured for detecting airspeed.

A method for predicting estimated times of arrival is disclosed in accordance with one or more illustrative embodiments of the present disclosure. In one illustrative embodiment, the method includes receiving a flight plan for an aircraft. In another illustrative embodiment, the method involves defining a ground path for the aircraft based on the flight plan, where the ground path is defined with respect to an ellipsoidal model of Earth and includes a plurality of flight legs. In another illustrative embodiment, the method involves integrating along the ground path for each of the flight legs using an energy-based method to generate aircraft states, where the integration steps are based on an integration step distance. In another illustrative embodiment, each integration step involves calculating the ground speed, traversal time, fuel consumed, and gross weight of the aircraft. In another illustrative embodiment, the method includes aggregating the traversal time of each integration step to determine a total traversal time for each waypoint. In another illustrative embodiment, the method determines an estimated time of arrival at each waypoint based on the total traversal time. In another illustrative embodiment, the method directs a transmission indicative of the estimated time of arrival at each waypoint.

In further aspects, the ground speed may be based on a set of nominal auto-throttle parameters specific to an aircraft type of the aircraft. In another aspect, the fuel consumed is calculated based on a fuel flow rate, which is calculated based on a required thrust, where the required thrust is based on the set of nominal auto-throttle parameters specific to the aircraft type of the aircraft. In another aspect, for an integration step configured for acceleration, the method includes receiving an acceleration value specific to an aircraft type of the aircraft, calculating a dependent thrust value required for the aircraft to maintain a constant airspeed, calculating an additional thrust value required to maintain the acceleration value based on the gross weight of the aircraft, determining a total required thrust by combining the dependent thrust value and the additional thrust value, and updating the aircraft states based on the total required thrust. In another aspect, for an integration step configured for deceleration, the method includes determining a deceleration value specific to an aircraft type of the aircraft, calculating a dependent thrust value required for the aircraft to maintain a constant airspeed, calculating a thrust reduction value required to achieve the deceleration value based on the gross weight of the aircraft, determining a total required thrust by subtracting the thrust reduction value from the dependent thrust value, and updating the aircraft states based on the total required thrust. In another aspect, the integrating along the ground path is configured to be performed during level flight while in a cruise mode.

This Summary is provided solely as an introduction to the subject matter that is fully described in the Detailed Description and Drawings. The Summary should not be considered to describe essential features nor be used to determine the scope of the Claims. Moreover, it is to be understood that both the foregoing Summary and the following Detailed Description are examples and explanatory only and are not necessarily restrictive of the subject matter claimed.

### BRIEF DESCRIPTION OF THE DRAWINGS

The detailed description is described with reference to the accompanying figures. The use of the same reference numbers in different instances in the description and the figures may indicate similar or identical items. Various embodiments or examples (“examples”) of the present disclosure are disclosed in the following detailed description and the accompanying drawings. The drawings are not necessarily to scale. In general, operations of disclosed processes may be performed in an arbitrary order, unless otherwise provided in the claims.

FIG. 1A illustrates a simplified block diagram of an aircraft including the system for predicting estimated times of arrival, in accordance with one or more embodiments of the present disclosure.

FIG. 1B illustrates the aircraft including the system, in accordance with one or more embodiments of the present disclosure.

FIG. 2 illustrates a diagram of a ground path connecting waypoints, in accordance with one or more embodiments of the present disclosure.

FIG. 3A illustrates a diagram of a radius to fix leg between two track-to-fix (TF) legs, in accordance with one or more embodiments of the present disclosure.

FIG. 3B illustrates a diagram of a fixed radius transition (FRT) between consecutive track-to-fix (TF) legs, in accordance with one or more embodiments of the present disclosure.

FIG. 4 illustrates a flow diagram illustrating steps performed in a method for predicting estimated times of arrival, in accordance with one or more embodiments of the present disclosure.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

Broadly speaking, embodiments of the present disclosure are directed to a system and method for determining estimated times of arrival (ETAs) for an aircraft to arrive at a set of waypoints using: parameters specific to each aircraft type such as auto-throttle parameters, an energy-based method of calculation rather than a kinetic method, and/or an ellipsoidal Earth model for calculating ground traversal distances.

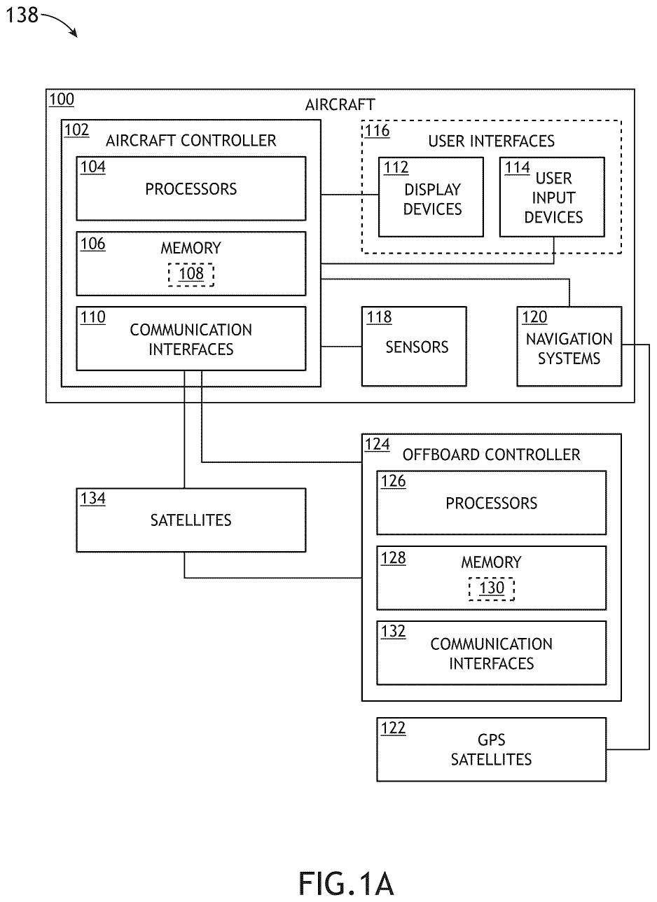

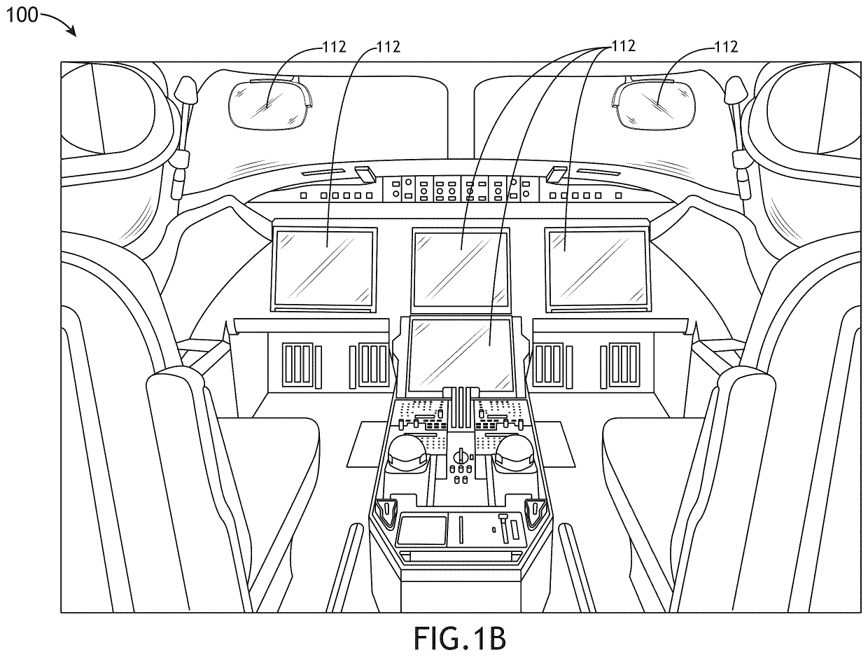

FIGS. 1A-1B illustrate an aircraft including a system 138 for predicting estimated times of arrival, in accordance with one or more embodiments of the present disclosure.

Referring now to FIG. 1A, the aircraft 100 may include an aircraft controller 102 (e.g., on-board/run-time controller). The aircraft controller 102 may include one or more processors 104, memory 106 configured to store one or more program instructions 108, and/or one or more communication interfaces 110.

The aircraft 100 may include an avionics environment such as, but not limited to, a cockpit. The aircraft controller 102 may be coupled (e.g., physically, electrically, and/or communicatively) to one or more display devices 112. The one or more display devices 112 may be configured to display three-dimensional images and/or two-dimensional images. Referring now to FIG. 1B, the avionics environment (e.g., the cockpit) may include any number of display devices 112 (e.g., one, two, three, or more displays) such as, but not limited to, one or more head-down displays (HDDs) 112, one or more head-up displays (HUDs) 112, one or more multi-function displays (MFDs), one or more adaptive flight displays (AFDs) 112, one or more primary flight displays (PFDs) 112, or the like. The one or more display devices 112 may be employed to present flight data including, but not limited to, aircraft states to a pilot or other crew member. For example, the aircraft states may be based on, but is not limited to, aircraft performance parameters, aircraft performance parameter predictions, sensor readings, alerts, or the like.

Referring again to FIG. 1A, the aircraft controller 102 may be coupled (e.g., physically, electrically, and/or communicatively) to one or more user input devices 114. The one or more display devices 112 may be coupled to the one or more user input devices 114. For example, the one or more display devices 112 may be coupled to the one or more user input devices 114 by a transmission medium that may include wireline and/or wireless portions. The one or more display devices 112 may include and/or be configured to interact with one or more user input devices 114.

The one or more display devices 112 and the one or more user input devices 114 may be standalone components within the aircraft 100. It is noted herein, however, that the one or more display devices 112 and the one or more user input devices 114 may be integrated within one or more common user interfaces 116.

Where the one or more display devices 112 and the one or more user input devices 114 are housed within the one or more common user interfaces 116, the aircraft controller 102, one or more offboard controllers 124, and/or the one or more common user interfaces 116 may be standalone components. It is noted herein, however, that the aircraft controller 102, the one or more offboard controllers 124, and/or the one or more common user interfaces 116 may be integrated within one or more common housings or chassis.

The aircraft controller 102 may be coupled (e.g., physically, electrically, and/or communicatively) to and configured to receive data from one or more aircraft sensors 118. The one or more aircraft sensors 118 may be configured to sense a particular condition(s) external or internal to the aircraft 100 and/or within the aircraft 100. The one or more aircraft sensors 118 may be configured to output data associated with particular sensed condition(s) to one or more components/systems onboard the aircraft 100. Generally, the one or more aircraft sensors 118 may include, but are not limited to, one or more inertial measurement units, one or more airspeed sensors, one or more radio altimeters, one or more flight dynamic sensors (e.g., sensors configured to sense pitch, bank, roll, heading, and/or yaw), one or more weather radars, one or more air temperature sensors, one or more surveillance sensors, one or more air pressure sensors, airspeed sensors, one or more engine sensors, and/or one or more optical sensors (e.g., one or more cameras configured to acquire images in an electromagnetic spectrum range including, but not limited to, the visible light spectrum range, the infrared spectrum range, the ultraviolet spectrum range, or any other spectrum range known in the art).

The aircraft controller 102 may be coupled (e.g., physically, electrically, and/or communicatively) to and configured to receive data from one or more navigational systems 120. The one or more navigational systems 120 may be coupled (e.g., physically, electrically, and/or communicatively) to and in communication with one or more GPS satellites 122, which may provide vehicular location data (e.g., aircraft location data) to one or more components/systems of the aircraft 100. For example, the one or more navigational systems 120 may be implemented as a global navigation satellite system (GNSS) device, and the one or more GPS satellites 122 may be implemented as GNSS satellites. The one or more navigational systems 120 may include a GPS receiver and a processor. For example, the one or more navigational systems 120 may receive or calculate location data from a sufficient number (e.g., at least four) of GPS satellites 122 in view of the aircraft 100 such that a GPS solution may be calculated.

It is noted herein the one or more aircraft sensors 118 may operate as a navigation system 120, being configured to sense any of various flight conditions or aircraft conditions typically used by aircraft and output navigation data (e.g., aircraft location data, aircraft orientation data, aircraft direction data, aircraft speed data, and/or aircraft acceleration data). For example, the various flight conditions or aircraft conditions may include altitude, aircraft location (e.g., relative to the Earth), aircraft orientation (e.g., relative to the Earth), aircraft speed, aircraft acceleration, aircraft trajectory, aircraft pitch, aircraft bank, aircraft roll, aircraft yaw, aircraft heading, air temperature, and/or air pressure. By way of another example, the one or more aircraft sensors 118 may provide aircraft location data and aircraft orientation data, respectively, to the one or more processors 104, 126.

The aircraft controller 102 of the aircraft 100 may be coupled (e.g., physically, electrically, and/or communicatively) to one or more offboard controllers 124.

The one or more offboard controllers 124 may include one or more processors 126, memory 128 configured to store one or more programs instructions 130 and/or one or more communication interfaces 132.

The aircraft controller 102 and/or the one or more offboard controllers 124 may be coupled (e.g., physically, electrically, and/or communicatively) to one or more satellites 134. For example, the aircraft controller 102 and/or the one or more offboard controllers 124 may be coupled (e.g., physically, electrically, and/or communicatively) to one another via the one or more satellites 134. For instance, at least one component of the aircraft controller 102 may be configured to transmit data to and/or receive data from at least one component of the one or more offboard controllers 124, and vice versa. Byway of another example, at least one component of the aircraft controller 102 may be configured to record event logs and may transmit the event logs to at least one component of the one or more offboard controllers 124, and vice versa. By way of another example, at least one component of the aircraft controller 102 may be configured to receive information and/or commands from the at least one component of the one or more offboard controllers 124, either in response to (or independent of) the transmitted event logs, and vice versa.

It is noted herein that the aircraft 100 and the components onboard the aircraft 100, the one or more offboard controllers 124, the one or more GPS satellites 122, and/or the one or more satellites 134 may be considered components of a system 138, for purposes of the present disclosure.

The one or more processors 104, 126 may include any one or more processing elements, micro-controllers, circuitry, field programmable gate array (FPGA) or other processing systems, and resident or external memory for storing data, executable code, and other information accessed or generated by the aircraft controller 102 and/or the one or more offboard controllers 124. In this sense, the one or more processors 104, 126 may include any microprocessor device configured to execute algorithms and/or program instructions. It is noted herein, however, that the one or more processors 104, 126 are not limited by the materials from which it is formed or the processing mechanisms employed therein and, as such, may be implemented via semiconductor(s) and/or transistors (e.g., using electronic integrated circuit (IC) components), and so forth. In general, the term “processor” may be broadly defined to encompass any device having one or more processing elements, which execute a set of program instructions from a non-transitory memory medium (e.g., the memory), where the set of program instructions is configured to cause the one or more processors to carry out any of one or more process steps.

The memory 106, 128 may include any storage medium known in the art suitable for storing the set of program instructions executable by the associated one or more processors. For example, the memory 106, 128 may include a non-transitory memory medium. For instance, the memory 106, 128 may include, but is not limited to, a read-only memory (ROM), a random access memory (RAM), a magnetic or optical memory device (e.g., disk), a magnetic tape, a solid state drive, flash memory (e.g., a secure digital (SD) memory card, a mini-SD memory card, and/or a micro-SD memory card), universal serial bus (USB) memory devices, and the like. The memory 106, 128 may be configured to provide display information to the display device (e.g., the one or more display devices 112). In addition, the memory 106, 128 may be configured to store user input information from a user input device of a user interface. The memory 106, 128 may be housed in a common controller housing with the one or more processors. The memory 106, 128 may, alternatively or in addition, be located remotely with respect to the spatial location of the processors and/or a controller. For instance, the one or more processors and/or the controller may access a remote memory (e.g., server), accessible through a network (e.g., internet, intranet, and the like).

The aircraft controller 102 and/or the one or more offboard controllers 124 may be configured to perform one or more process steps, as defined by the one or more sets of program instructions 108, 130. The one or more process steps may be performed iteratively, concurrently, and/or sequentially. The one or more sets of program instructions 108, 130 may be configured to operate via a control algorithm, a neural network (e.g., with states represented as nodes and hidden nodes and transitioning between them until an output is reached via branch metrics), a kernel-based classification method, a Support Vector Machine (SVM) approach, canonical-correlation analysis (CCA), factor analysis, flexible discriminant analysis (FDA), principal component analysis (PCA), multidimensional scaling (MDS), principal component regression (PCR), projection pursuit, data mining, prediction-making, exploratory data analysis, supervised learning analysis, Boolean logic (e.g., resulting in an output of a complete truth or complete false value), fuzzy logic (e.g., resulting in an output of one or more partial truth values instead of a complete truth or complete false value), or the like. For example, in the case of a control algorithm, the one or more sets of program instructions 108, 130 may be configured to operate via proportional control, feedback control, feedforward control, integral control, proportional-derivative (PD) control, proportional-integral (PI) control, proportional-integral-derivative (PID) control, or the like.

The one or more communication interfaces 110, 132 may be operatively configured to communicate with one or more components of the aircraft controller 102 and/or the one or more offboard controllers 124. For example, the one or more communication interfaces 110, 132 may also be coupled (e.g., physically, electrically, and/or communicatively) with the one or more processors 104, 126 to facilitate data transfer between components of the one or more components of the aircraft controller 102 and/or the one or more offboard controllers 124 and the one or more processors 104, 126. For instance, the one or more communication interfaces 110, 132 may be configured to retrieve data from the one or more processors 104, 126, or other devices, transmit data for storage in the memory 106, 128, retrieve data from storage in the memory 106, 128, or the like. By way of another example, the aircraft controller 102 and/or the one or more offboard controllers 124 may be configured to receive and/or acquire data or information from other systems or tools by a transmission medium that may include wireline and/or wireless portions. By way of another example, the aircraft controller 102 and/or the one or more offboard controllers 124 may be configured to transmit data or information (e.g., the output of one or more procedures of the inventive concepts disclosed herein) to one or more systems or tools by a transmission medium that may include wireline and/or wireless portions (e.g., a transmitter, receiver, transceiver, physical connection interface, or any combination). In this regard, the transmission medium may serve as a data link between the aircraft controller 102 and/or the one or more offboard controllers 124 and the other subsystems (e.g., of the aircraft 100 and/or the system 138). In addition, the aircraft controller 102 and/or the one or more offboard controllers 124 may be configured to send data to external systems via a transmission medium (e.g., network connection).

The one or more display devices 112 may include any display device known in the art. For example, the display devices 112 may include, but are not limited to, one or more head-down displays (HDDs), one or more HUDs, one or more multi-function displays (MFDs), or the like. For instance, the display devices 112 may include, but are not limited to, a liquid crystal display (LCD), a light-emitting diode (LED) based display, an organic light-emitting diode (OLED) based display, an electroluminescent display (ELD), an electronic paper (E-ink) display, a plasma display panel (PDP), a display light processing (DLP) display, or the like. Those skilled in the art should recognize that a variety of display devices may be suitable for implementation in the present invention and the particular choice of display device may depend on a variety of factors, including, but not limited to, form factor, cost, and the like. In a general sense, any display device capable of integration with the user input device (e.g., touchscreen, bezel mounted interface, keyboard, mouse, trackpad, and the like) is suitable for implementation in the present invention.

The one or more user input devices 114 may include any user input device known in the art. For example, the user input device 114 may include, but is not limited to, a keyboard, a keypad, a touchscreen, a lever, a knob, a scroll wheel, a track ball, a switch, a dial, a sliding bar, a scroll bar, a slide, a handle, a touch pad, a paddle, a steering wheel, a joystick, a bezel input device, or the like. In the case of a touchscreen interface, those skilled in the art should recognize that a large number of touchscreen interfaces may be suitable for implementation in the present invention. For instance, the display device may be integrated with a touchscreen interface, such as, but not limited to, a capacitive touchscreen, a resistive touchscreen, a surface acoustic based touchscreen, an infrared based touchscreen, or the like. In a general sense, any touchscreen interface capable of integration with the display portion of a display device is suitable for implementation in the present invention. In another embodiment, the user input device may include, but is not limited to, a bezel mounted interface.

The system 138 may include or be various systems. For example, the system 138 may be a flight management system (FMS) configured to be used on an airplane 100. The system 138 may include a flight management system comprising the controller 102. The controller 102 may be an aircraft controller 102. The system 138 may further include a sensor 118 (e.g., wind sensor) configured for detecting true airspeed.

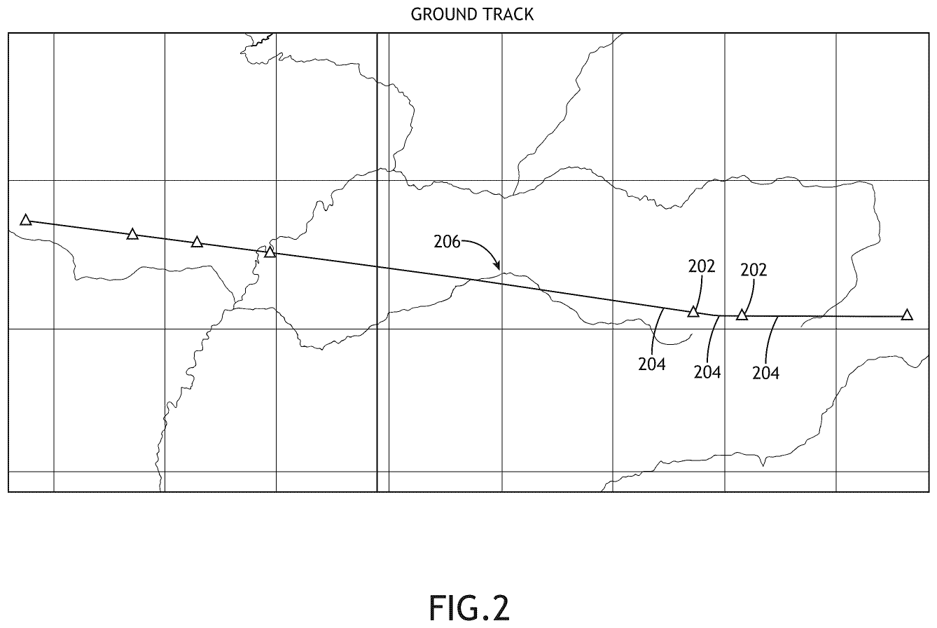

FIG. 2 illustrates a diagram of a ground path 206 connecting waypoints 202, in accordance with one or more embodiments of the present disclosure.

In embodiments, the ground path 206 may include a plurality of flight legs 204. Each flight leg 204 may, but is not required to, start and end at a waypoint 202. For example, the flight legs 204 may be included in a flight plan received by controller 102 from air traffic control. The controller 102 may be configured to modify the flight legs 204, such as adding fixed radius transitions between consecutive flight legs 204 to smooth out turns using particular radii and/or bank angles as will be disclosed in the present disclosure.

In some embodiments, the ground path 206 is defined with respect to a model of the Earth. For example, the ground path 206 may be defined with respect to an ellipsoidal model of the Earth. For instance, the ellipsoidal model of the Earth may be a WGS-84 ellipsoidal Earth model. Distances may be calculated between points of a flight leg 204 using the ellipsoidal model of the Earth rather than a spherical model of the Earth. The ellipsoidal model of the Earth may improve accuracy of the system 138 since the Earth is not a perfect sphere.

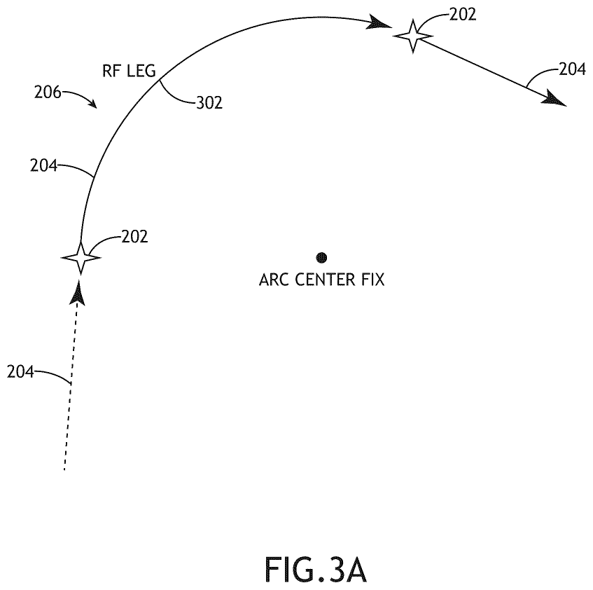

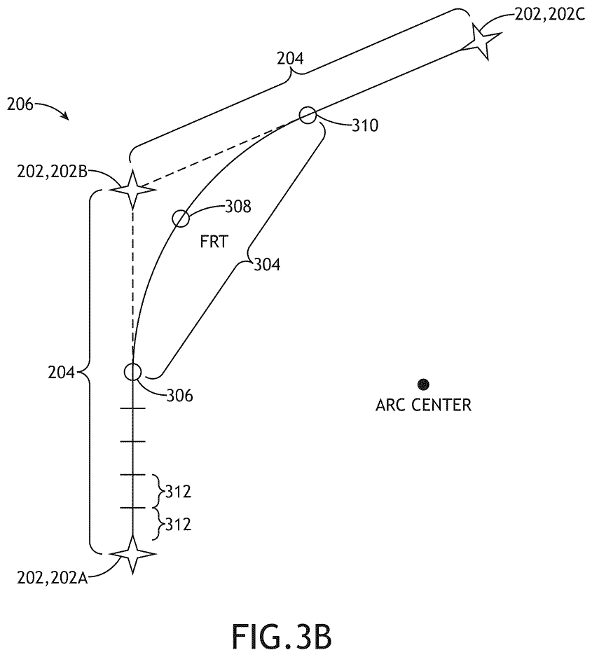

FIG. 3A illustrates a diagram of a radius to fix (RF) leg 302 between two track-to-fix (TF) legs 204, in accordance with one or more embodiments of the present disclosure. Embodiments herein may allow for accurately predicting traversal along all of the flight legs 204 of a ground path 206 by accounting for factors such as constant changes in relative wind speed and direction acting on the aircraft 100 while making turns.

FIG. 3B illustrates a diagram of a fixed radius transition (FRT) 304 between consecutive track-to-fix (TF) legs 204, in accordance with one or more embodiments of the present disclosure.

In embodiments, aircraft states (e.g., gross weight, ground speed, and/or the like) of the aircraft 100 may be determined at discrete integration steps. The integration steps may be based on an integration step distance 312. The size of the integration step distance 312 changes the accuracy. A smaller integration step distance 312 improves the accuracy, but increases the number of computations required.

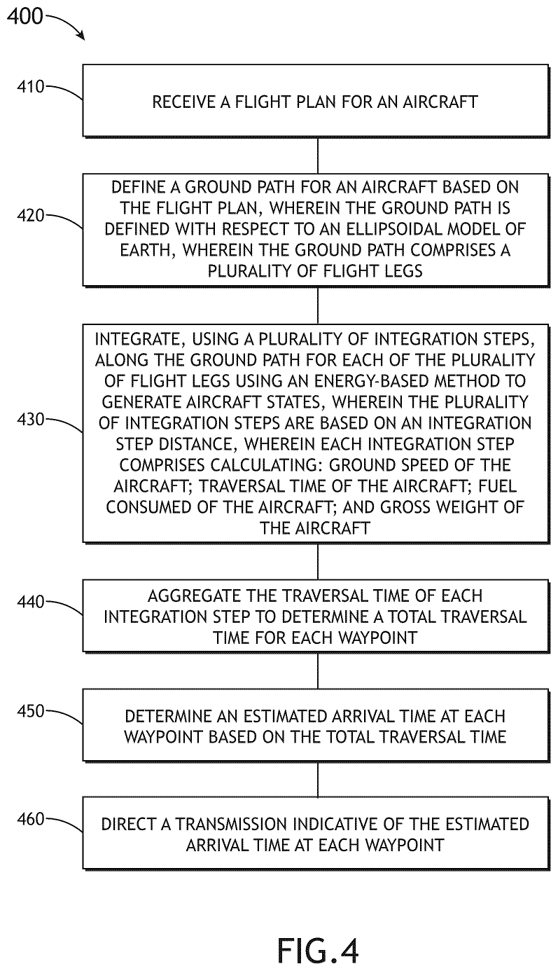

The ground path 206 may include a fixed radius transition 304 between consecutive track-to-fix (TF) legs 204. For example, the fixed radius transition 304 may be added according to a set of rules. As discussed further in step 420 of FIG. 4, the controller 102 may be configured to calculate a radius of turn for each fixed radius transition based on ground speeds calculated at three or more points of the fixed radius transition 304.

The controller 102 may be configured to receive a flight plan that includes a first TF leg 204 connecting a first waypoint 202A to a second waypoint 202B. The flight plan may include a second TF leg 204 connecting a second waypoint 202B to a third waypoint 202C. The fixed radius transition (FRT) 304 may include a start point 306, and an end point 310. For example, the start point 306 may be located along the first TF leg 204 and the end point 310 may be located along the second TF leg 204. The fixed radius transition 304 may include a midpoint 308.

FIG. 4 illustrates a flow diagram illustrating steps performed in a method 400 for predicting estimated times of arrival, in accordance with one or more embodiments of the present disclosure. It is noted that the embodiments and enabling technologies described previously herein in the context of the system 138 should be interpreted to extend to the method 400. It is further noted herein that the steps of method 400 may be implemented all or in part by system 138. It is further recognized, however, that the method 400 is not limited to the system 138 in that additional or alternative system-level embodiments may carry out all or part of the steps of method 400.

At step 410, a flight plan for an aircraft 100 is received. For example, the controller 102 may be configured to receive the flight plan for the aircraft 100. For instance, the flight plan may be received or determined using a controller, such as controller 102 or controller 124. For instance, the flight plan may be received from air traffic control.

At step 420, a ground path 206 for the aircraft 100 is defined based on the flight plan. The ground path 206 may be defined with respect to an ellipsoidal model of Earth. For example, the controller 102 may be configured to define the ground path 206 for the aircraft 100 based on the flight plan. For instance, the flight plan may include waypoints 202 as coordinates (e.g., latitude and longitude) and the coordinates may be mathematically defined (e.g., projected) onto an ellipsoidal model of Earth for purposes of calculating straight and curved lines between the coordinates. For instance, using the ellipsoidal model of Earth, the ground path 206 may be defined using geodesic principles, which consider the shortest path between two points on the Earth's surface. This is particularly relevant when using an ellipsoidal model of the Earth, as it accounts for the Earth's oblate shape. In this regard, a geodesic path is analogous to a line on a plane surface but occurs on the curved surface of an ellipsoid. Any methodology of calculating a geodesic path known in the art of mathematics may be used, such as, but not limited to, Vincenty's formulae for oblate spheroids. This approach enhances navigational accuracy by aligning with the ellipsoidal model's representation of Earth's surface.

In embodiments, the defining the ground path 206 may include adding transitions or any other type of modification such as smoothing out corners or the like. This may make the flight plan more practical, more efficient, safer, and/or the like.

In embodiments, the defining the ground path 206 may include adding a fixed radius transition (FRT) 304 between each set of consecutive straight legs 204 (e.g., TF legs). Two straight legs create a sharp corner and the FRT 304 smooths this out.

In embodiments, the defining the ground path 206 may include calculating a radius of turn for each fixed radius transition 304 (e.g., see FIG. 3B) of the plurality of flight legs 204. Calculating the radius of turn may include determining a first ground speed at the start point 306 of the fixed radius transition 304. Calculating the radius of turn may include determining a second ground speed at midpoint 308 of the fixed radius transition 304. Calculating the radius of turn may include determining a third ground speed at the end point 310 of the fixed radius transition 304. Calculating the radius of turn may include selecting a maximum ground speed from a group including the first ground speed, the second ground speed, and the third ground speed. For example, calculating the radius of turn may include selecting a maximum ground speed from a group consisting of only the first ground speed, the second ground speed, and the third ground speed. Next, the radius of turn may be determined based on the maximum ground speed and a predetermined bank angle.

For example, the maximum ground speed (i.e., the maximum of the three ground speeds) may be used to calculate an arc radius of the turn as follows:

$${R}_{d} = \frac{{V}_{g}^{2}}{tan ( {bank}_{angle} ) * g}$$

where R_{d} is the turn radius, bank_angle is the bank angle, and g is gravity. The bank_angle may be set as equal to the minimum of the following values: 16 or (change_in_course)/2 in degrees, where change_in_course is a measurable angle defining the change in angle of the turn (e.g., 30 degree turn). The R_{d} may be set to have a minimum value of 1.38 nautical miles (nmi).

At step 430, a plurality of integration steps are used to integrate along the ground path 206 for each of the plurality of flight legs 204 using an energy-based method to generate aircraft states. The plurality of integration steps may be based on the integration step distance 312. Each integration step may include calculating a ground speed of the aircraft 100, a traversal time of the aircraft 100, fuel consumed by the aircraft 100, and a gross weight of the aircraft 100. For example, the controller 102 may be configured to integrate along the ground path 206 for each of the plurality of flight legs 204 using the energy-based method and update the aircraft state values over time.

The calculations and descriptions for a single loop of a flight leg 204 are described in more detail below. Each loop of each flight leg 204 may itself contain sub-loops for a plurality of integration steps of the flight leg 204. Each loop of each flight leg 204 may define an integration step distance 312 (Seg_Len) used by the energy method to carry out integration from a current aircraft location to a given waypoint 202.

In embodiments, at the beginning of the loop of a flight leg 204, the controller 102 may be configured to retrieve start and end coordinates for the flight leg 204, a planned altitude, and a planned speed profile. In the case of an RF leg comprising a turn of the ground path 206, the controller 102 may be configured to retrieve coordinates of a turn center, radius of the turn, and direction of the turn.

In embodiments, next, the controller 102 may be configured to calculate a geodesic leg length (Leg_Length) for each straight flight leg 204 (e.g., TF leg) and a geodesic arc length for each curved flight leg (e.g., RF leg). Furthermore, the controller 102 may be configured to calculate an aircraft track angle at the beginning of the flight leg 204.

For many of the following calculations of the present disclosure, consider an aircraft type of the Bombardier Global 5000 jet. However, embodiments herein may be used with any aircraft type known in the art and the examples and descriptions herein associated with the Bombardier Global 5000 jet are for illustrative purposes only.

For an integration step configured for acceleration, such as an acceleration mode for increasing airspeed in cruise, the controller 102 may be configured to receive (e.g., receive a nominal known value for) an acceleration value corresponding to, and specific to, an aircraft type of the aircraft 100. The controller 102 may be configured to calculate a dependent thrust value required for the aircraft 100 to maintain a constant airspeed. The controller 102 may be configured to calculate an additional thrust value required to maintain the acceleration value based on the gross weight of the aircraft 100. The controller 102 may be configured to determine a total required thrust by combining the dependent thrust value and the additional thrust value. The controller 102 may be configured to update the aircraft states based on the total required thrust.

For example, parameters (e.g., auto-throttle parameters) associated with the aircraft type may include acceleration, d. In embodiments, it is assumed that the acceleration value is reached instantaneously for the prediction of ETA. For the Bombardier Global 5000 aircraft, the acceleration a may be a fixed value, such as 0.7 knots/sec.

Note that the auto-throttle parameters may be determined using any method known in the art, such as recording historic data and using the historic data to determine the parameters, basing the parameters on known specifications of the engine and/or aircraft manufacturer specifications associated with the aircraft type, simulating the parameters using Finite Element Analysis such as drag studies, and/or the like. For example, in a simplified method for illustrative purposes only, a fuel flow rate corresponding to the aircraft type may be based on a historic measurement of the aircraft flying at a constant airspeed and keeping track of the amount of fuel used per unit of time at that airspeed.

In this acceleration mode, the thrust mode may be set to a level flight in cruise, rather than descent or climb.

The current true airspeed (VTₐₛ) in knots may be calculated. For example, the controller 102 may be configured to calculate the VTₐₛ based on a specified Mach value.

The dependent thrust, Thrust_{Dependent}, may be defined as the thrust required to maintain a constant airspeed. For example, this may be calculated or known based on known drag values specific to the aircraft type. Additional Thrust required to maintain the required acceleration, ā, may be calculated by the Newton's Second Law as follows:

$${Thrust}_{Additional} = \frac{GW}{g} \times \overline{a}$$

where GW is the gross weight of the aircraft 100 and g is gravity.

Thus, the Total Thrust Required may be calculated as follows:

$${Thrust}_{Required} = {Thrust}_{Dependent} + {Thrust}_{Additional}$$

The acceleration mode may be configured to be triggered and used when a threshold is breached. For example, the above calculations may be performed based on a threshold difference of an aircraft speed being below a target speed as follows:

aircraft_speed−target_speed<−0.005 Mach

wherein aircraft_speed is a current speed of the aircraft 100 and target_speed is a target speed of the aircraft 100 that is desired. For instance, the aircraft_speed may be detected using sensors 118, GPS, or the like and the target_speed may be received. For instance, the target_speed may, but is not required to, be received from the system 138 (e.g., FMS system). For example, the target_speed may be based on a calculated speed needed to reach a waypoint 202 by a desired time based on current position and distance to the waypoint 202.

Similarly, in a deceleration mode, the equation for the threshold may be as follows:

$$aircraft\_speed - target\_speed > + 0.005 Mach$$

For an integration step configured for deceleration, in the deceleration mode, the controller 102 may be configured to determine (or receive a known value for) a deceleration value corresponding to, and specific to, the aircraft type of the aircraft 100. The controller 102 may be configured to calculate a dependent thrust value required for the aircraft 100 to maintain a constant airspeed. The controller 102 may be configured to calculate a thrust reduction value required to achieve the deceleration value based on the gross weight of the aircraft 100. The controller 102 may be configured to determine a total required thrust by subtracting the thrust reduction value from the dependent thrust value. The controller 102 may be configured to update the aircraft states based on the total required thrust.

For the Bombardier Global 5000 aircraft, the deceleration a may be a fixed value, such as −1.86 knots/sec.

The current true airspeed (VTₐₛ) may be calculated (e.g., calculated in knots). For example, the controller 102 may be configured to calculate the VTₐₛ based on a specified Mach value.

The dependent thrust, Thrust_{Dependent}, may be defined and calculated as described above.

Similarly, the Total Thrust Required may be calculated as follows:

$${Thrust}_{Required} = {Thrust}_{Dependent} + {Thrust}_{Additional}$$

For an integration step configured for constant speed, in a zero-acceleration mode (e.g., constant speed mode), the calculations may be simpler. For example, since acceleration, ā, is zero, then Thrust_{Required}=Thrust_{Dependent}. In this way, the integrating along the ground path 206 may be configured to be performed during level flight while in a cruise mode.

In embodiments, for each integration step, the ground speed may be based on the set of nominal auto-throttle parameters specific to the aircraft type of the aircraft 100.

The ground speed may be based on a true airspeed and wind data. Calculating the ground speed for each integration step may include receiving wind magnitude data and wind direction data. Calculating the ground speed may include calculating an along-track wind component and a cross-track wind component based on the wind magnitude data, the wind direction data, and a current aircraft track angle. Calculating the ground speed may include determining a true airspeed component adjusted for the cross-track wind component and combining the true airspeed component with the along-track wind component.

In embodiments, for each integration step, the ground speed may be based on an aircraft track angle at a beginning of the integration step and also be based on true airspeed (VTₐₛ) and wind. For example, the true airspeed (VTₐₛ) at the beginning of the segment may be assumed to be constant.

For example, equations in the following form, or derivable from the following form, may be used to determine ground speed (V_{g}):

$$wEast = wMag * sin ( wDir )$$

$$wNorth = wMag * cos ( wDir )$$

$$wAtk = wNorth * cos ( {ac}_{trk} ) + wEast * sin ( {ac}_{trk} )$$

$$wXtk = wNorth * sin ( {ac}_{trk} ) - wEast * cos ( {ac}_{trk} )$$

$$tasAtk = \sqrt{{VTas}^{2} - {wXtk}^{2}}$$

$${V}_{g} = tasAtk + wAtk$$

where V_{g} is ground speed, wMag is the magnitude of the wind, wDir is the direction of the wind, and acₜᵣₖ is the track angle of the aircraft 100.

In embodiments, for each integration step, for RF or FRT legs, a bank angle may be calculated. The bank angle may be a bank angle that is required based on the ground speed V_{g} from the equation above, and may be used to validate that an aircraft turn (e.g., curved flight leg 204 with a particular radius) is flyable.

For example, the controller 102 may be configured to calculate a cosine of a drift angle, cos β. For example, equations in the following form, or derivable from the following form, may be used to determine the drift angle, cos β:

$$cos β = \frac{{VTas}^{2} + {V}_{g}^{2} - {wMag}^{2}}{2 * {V}_{g} * VTas}$$

$${ϕ}_{R} = {tan}^{- 1} ( \frac{{V}_{g}^{2}}{{R}_{d} * g * cos ( β )} )$$

where Ø_{R} is the bank angle that is required.

The controller 102 may be configured to validate a corresponding arc path of the flight leg 204 is flyable. For example, the controller 102 may be configured to only use the bank angle if the bank angle is less than a maximum allowable known bank angle, Bank_Angle_Max. The maximum allowable known bank angle may be based on limits of safety when turning of the aircraft 100. For instance, such a comparison to the maximum allowable known bank angle may be made as follows:

$${ϕ}_{R} < Bank\_Angle \_Max$$

In embodiments, for each integration step, the fuel consumed may be calculated based on a fuel flow rate. The fuel flow rate may be calculated based on the required thrust, Thrust_{Required}. The required thrust, Thrust_{Required}, may be based on a set of nominal auto-throttle parameters (e.g., acceleration values in knots/second, drag values of the aircraft at true airspeed) specific to the aircraft type of the aircraft 100.

In embodiments, for a last integration step, such as a last integration step in a flight leg 204 that is less than the integration step distance 312, the integration step distance 312 may be adjusted. For example, if the next and final integration step distance 312 is identified as being less than half of the integration step distance 312, then this integration step distance 312 may be added to the previous/current integration step. For example, the logic may be as follows:
if the (Leg_length−Distance_covered)<1.5*Seg_Len,
then Actual_Seg_Len=Leg_Length−Distance_covered,
else Actual_Leg_Len=Seg_Len,

where Seg_Len is the integration step distance 312, Leg_Length is total length of the flight leg 204, Distance_covered is previous aggregated distance of previous integration steps.

For example, for a Leg_length=71 nmi and Seg_Len=5 nmi, the integration step distance 312 of the last integration step may be a length of 6 nmi. If Leg_length=73 nmi and Seg_Len=5 nmi, the integration step distance 312 of the last integration step may be a length of 3 nmi.

In embodiments, for each integration step, the aircraft track angle (acₜᵣₖ) and coordinates/position (e.g., latitude and longitude) of the aircraft 100 may be configured to be determined/updated.

For example, for TF legs (e.g., straight flight legs), three or more steps may be used. For example, newest aircraft coordinates (ac_lat_new and ac_lon_new) at an end of the integration step may be calculated. Next, variables corresponding to the aircraft coordinates (e.g., ac_lat, ac_lon) may be updated to be equal to the newest aircraft coordinates. Thereafter, a course (e.g., ground path 206) from the updated aircraft coordinates to the furthest end point of the current TF leg may be re-calculated (e.g., ac_trk=ac_trk_new).

For RF legs and FRT transitions (e.g., curved legs/segments), several steps may be used to determine/update the aircraft track angle (acₜᵣₖ) and coordinates/position (e.g., latitude and longitude) of the aircraft 100 at each integration step. The arc extent (φ) may be calculated for each integration step using a circular approximation. The equation used may be φ=Actual_Seg_Len/R_{d}. This calculation may assist in determining the precise path of the aircraft during curved segments.

The coordinates of the aircraft at the start of each integration step may be stored as pt2.lat and pt2.lon. The course (e.g., ground path 206) from the turn center to the aircraft location at the start of the integration step (pt2) may be calculated as crs12.

Subsequently, the course from the turn center to the new aircraft location may be calculated as crs13. The equation used may be:

$$crs 13 = crs 12 - ϕ * turn\_dir ,$$

where turn_dir may be −1 for a right turn and +1 for a left turn, and 0 for a straight TF leg. The angle may be converted from degrees to radians, between −pi to pi.

The aircraft coordinates at the end of the integration step (pt3.lat and pt3.lon) may be calculated using the course from the turn center to the aircraft position at the end of the integration step (crs13) and the arc extent.

The aircraft location may then be updated, setting ac_lat to pt3.lat and ac_lon to pt3.lon. This may enable the aircraft's location to be accurately reflected after each integration step.

The arc length, which may be equal to the actual integration step length (Actual_Seg_Len), may be recalculated to ensure precision in the aircraft's path.

The aircraft track, ac_trk, which is perpendicular to the course from the turn center to the aircraft location, may be calculated. For example, crs13 (the course from the turn center to the aircraft location at the end of the integration step) may be updated using the following equation:

$$ac\_trk = crs 13 - ( pi / 2 ) * turn\_dir$$

where turn_dir may be −1 for a right turn and +1 for a left turn and 0 for straight. The aircraft track may be configured to be a radian value between −pi to pi.

In embodiments, the traversal time of the aircraft 100 may be configured to be calculated and aggregated towards a total traversal time.

The traversal time required to traverse one integration step may be calculated and accumulated towards the total traversal time. The traversal time for one integration step (deltaT) may be calculated using the equation:

$$deltaT = Actual\_Seg \_Len / {V}_{g}$$

The leg traversal time (TimeLeg) for the flight leg 204 may be updated as follows:

$$TimeLeg = {TimeLeg}_{previous} + deltaT$$

The true airspeed at the end of one integration step may be calculated, accounting for acceleration and deceleration, using the following equation:

$${VT}_{as 2} = {VT}_{as 1} + \overline{a} \times deltaT$$

Each integration step may further include calculating the gross weight of the aircraft 100 based on the fuel consumed. The speed (e.g., Mach value) corresponding to VTₐₛ₂ may be calculated, and the current aircraft speed (e.g., in Mach) may be determined and updated. The fuel consumed (Fuelₛₜₑₚ) for one integration step may be calculated and subtracted from the aircraft gross weight. The equations used may be:

$${Fuel}_{step} = fuelFlow \times deltaT \times Number of Engines$$

$$GW = {GW}_{previous} - {Fuel}_{step}$$

where, GW is the updated GW, and fuelFlow is the fuel used per unit of time per engine of a particular aircraft type.

The distance traversed may be updated by adding the actual segment length to the total distance covered so far. The equation used may be:

$$Distance\_covered = {Distance\_covered}_{previous} + Actual\_Seg \_Len$$

The equations and descriptions above, as noted, may be used in the sub-loop corresponding to the single integration step.

At step 440, referring now to a period spanning multiple integration steps, the traversal time of each integration step is aggregated to determine a total traversal time for each waypoint 202. For example, the controller 102 may be configured to sum the traversal times of each integration step between each waypoint 202 in order to determine the total traversal time, TimeLeg, between each waypoint 202 or other start and end point of a leg or transition. There may be one or more total traversal times depending on the number of waypoints 202.

In embodiments, the total traversal time for multiple flight legs 204 may be aggregated to determine the estimated time of arrival (ETA) relative to a starting waypoint 202 to any other particular waypoint 202. For example, to determine the estimated time of arrival (ETA) at the most recent waypoint 202, the following equation may be used:

$${Time}_{tot} = {Time}_{{tot}_{previous}} + TimeLeg$$

where TimeLeg is the leg traversal time of the most recent flight leg 204, and Timeₜₒₜ is the total traversal time to that waypoint.

In this way, the estimated time of arrival (ETA) for each waypoint 202 may be stored in memory 106 over time, as each flight leg 204 is iterated through.

At step 450, the ETA at each waypoint 202 is determined based on the one or more total traversal times. For example, the controller 102 may be configured to determine the ETA at each waypoint 202 based on the one or more total traversal times. For instance, the one or more total traversal times may be added to a current time (14:30:56.89 CST) of a controller 102 to determine one or more ETAs for the plurality of waypoints 202.

At step 460, a transmission indicative of the ETA at each waypoint is directed. For example, the controller 102 may be configured to direct the transmission indicative of the ETA at each waypoint to be performed by an antenna of the communication interface 110. For instance, the transmission may include an ADS-C transmission to air traffic control. For instance, the transmission may include an Extended Projected Profile (EPP) message.

In embodiments, the system 138 may be configured to display a graphic indicative of the results on a display 112. For example, the graphic (e.g., ETAs in time format HH:MM:SS for each waypoint 202) indicative of the estimated time of arrival at each waypoint 202 may be configured to be displayed on the display 112.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “in embodiments”, “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination or sub-combination of two or more such features, along with any other features which may not necessarily be expressly described or inherently present in the instant disclosure.

It is to be understood that embodiments of the methods disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried in addition to, or as substitutes to one or more of the steps disclosed herein.

Although inventive concepts have been described with reference to the embodiments illustrated in the attached drawing figures, equivalents may be employed and substitutions made herein without departing from the scope of the claims. Components illustrated and described herein are merely examples of a system/device and components that may be used to implement embodiments of the inventive concepts and may be replaced with other devices and components without departing from the scope of the claims. Furthermore, any dimensions, degrees, and/or numerical ranges provided herein are to be understood as non-limiting examples unless otherwise specified in the claims.

What is claimed:

1. A system for predicting estimated times of arrival, the system comprising:
a controller including one or more processors configured to execute a set of program instructions stored in a memory, the set of program instructions configured to cause the one or more processors to:
receive a flight plan for an aircraft;
define a ground path for the aircraft based on the flight plan, wherein the ground path is defined with respect to an ellipsoidal model of Earth, wherein the ground path comprises a plurality of flight legs;
integrate, using a plurality of integration steps, along the ground path for each of the plurality of flight legs using an energy-based method to generate aircraft states, wherein the plurality of integration steps are based on an integration step distance,
wherein each integration step comprises:
calculating:
ground speed of the aircraft;
traversal time of the aircraft;
fuel consumed of the aircraft; and
gross weight of the aircraft;
aggregate the traversal time of each integration step to determine a total traversal time for each waypoint;
determine an estimated time of arrival at each waypoint based on the total traversal time; and
direct a transmission indicative of the estimated time of arrival at each waypoint.

2. The system of claim 1, wherein the ground speed is based on a set of nominal auto-throttle parameters specific to an aircraft type of the aircraft.

3. The system of claim 2, wherein the fuel consumed is calculated based on a fuel flow rate, wherein the fuel flow rate is calculated based on a required thrust, wherein the required thrust is based on the set of nominal auto-throttle parameters specific to the aircraft type of the aircraft.

4. The system of claim 1, wherein, for an integration step configured for acceleration, the controller is configured to:
receive an acceleration value corresponding to, and specific to, an aircraft type of the aircraft;
calculate a dependent thrust value required for the aircraft to maintain a constant airspeed;
calculate an additional thrust value required to maintain the acceleration value based on the gross weight of the aircraft;
determine a total required thrust by combining the dependent thrust value and the additional thrust value; and
update the aircraft states based on the total required thrust.

5. The system of claim 1, wherein, for an integration step configured for deceleration, the controller is configured to:
determine a deceleration value corresponding to, and specific to, an aircraft type of the aircraft;
calculate a dependent thrust value required for the aircraft to maintain a constant airspeed;
calculate a thrust reduction value required to achieve the deceleration value based on the gross weight of the aircraft;
determine a total required thrust by subtracting the thrust reduction value from the dependent thrust value; and
update the aircraft states based on the total required thrust.

6. The system of claim 1, wherein the integrating along the ground path is configured to be performed during level flight while in a cruise mode.

7. The system of claim 1, wherein the ground speed is based on a true airspeed and wind data.

8. The system of claim 1, wherein each integration step further comprises calculating:
the gross weight of the aircraft based on the fuel consumed.

9. The system of claim 1, wherein the transmission includes an Extended Projected Profile (EPP) message.

10. The system of claim 1, wherein the ellipsoidal model of the Earth is a WGS-84 ellipsoidal Earth model.

11. The system of claim 1, wherein the ground path includes a fixed radius transition between consecutive track-to-fix (TF) legs.

12. The system of claim 11, wherein defining the ground path comprises:
calculating a radius of turn for each fixed radius transition of the plurality of flight legs by:
determining a first ground speed at a start point of the fixed radius transition;
determining a second ground speed at a midpoint of the fixed radius transition;
determining a third ground speed at an end point of the fixed radius transition;
selecting a maximum ground speed from a group comprising the first ground speed, the second ground speed, and the third ground speed; and
determining the radius of turn based on the maximum ground speed and a predetermined bank angle.

13. The system of claim 1, wherein calculating the ground speed for each integration step comprises:
receiving wind magnitude data and wind direction data;
calculating an along-track wind component and a cross-track wind component based on the wind magnitude data, the wind direction data, and a current aircraft track angle;
determining a true airspeed component adjusted for the cross-track wind component; and
calculating the ground speed by combining the true airspeed component with the along-track wind component.

14. The system of claim 1, wherein the system comprises a flight management system comprising the controller and wherein the controller is an aircraft controller,
wherein the system further comprises a sensor configured for detecting airspeed.

15. A method for predicting estimated times of arrival, the method comprising:
receive a flight plan for an aircraft;
define a ground path for the aircraft based on the flight plan, wherein the ground path is defined with respect to an ellipsoidal model of Earth, wherein the ground path comprises a plurality of flight legs;
integrate, using a plurality of integration steps, along the ground path for each of the plurality of flight legs using an energy-based method to generate aircraft states, wherein the plurality of integration steps are based on an integration step distance,
wherein each integration step comprises:
calculating:
ground speed of the aircraft;
traversal time of the aircraft;
fuel consumed of the aircraft; and
gross weight of the aircraft;
aggregate the traversal time of each integration step to determine a total traversal time for each waypoint;
determine an estimated time of arrival at each waypoint based on the total traversal time; and
direct a transmission indicative of the estimated time of arrival at each waypoint.

16. The method of claim 15, wherein the ground speed is based on a set of nominal auto-throttle parameters specific to an aircraft type of the aircraft.

17. The method of claim 16, wherein the fuel consumed is calculated based on a fuel flow rate, wherein the fuel flow rate is calculated based on a required thrust, wherein the required thrust is based on the set of nominal auto-throttle parameters specific to the aircraft type of the aircraft.

18. The method of claim 15, further comprising, for an integration step configured for acceleration:
receiving an acceleration value corresponding to, and specific to, an aircraft type of the aircraft;
calculating a dependent thrust value required for the aircraft to maintain a constant airspeed;
calculating an additional thrust value required to maintain the acceleration value based on the gross weight of the aircraft;
determining a total required thrust by combining the dependent thrust value and the additional thrust value; and
updating the aircraft states based on the total required thrust.

19. The method of claim 15, further comprising, for an integration step configured for deceleration:
determining a deceleration value corresponding to, and specific to, an aircraft type of the aircraft;
calculating a dependent thrust value required for the aircraft to maintain a constant airspeed;
calculating a thrust reduction value required to achieve the deceleration value based on the gross weight of the aircraft;
determining a total required thrust by subtracting the thrust reduction value from the dependent thrust value; and
updating the aircraft states based on the total required thrust.

20. The method of claim 15, wherein the integrating along the ground path is configured to be performed during level flight while in a cruise mode.
